(19) United States
(12) Patent Application Publication
(10) Pub. No.: US 2017/0177686 A1
(43) Pub. Date: Jun. 22, 2017

(54) PROPERTY MODELS ON MOBILE DEVICES

(71) Applicant: SAP SE, Walldorf (DE)

(72) Inventors: Thomas BIESEMANN, Bruchsal (DE); Gerd RITTER, Heidelberg (DE)

(21) Appl. No.: 14/976,515

(22) Filed: Dec. 21, 2015

(51) Int. Cl. G06F 17/30; H04L 29/08; H04L 29/06

(52) U.S. Cl. CPC G06F 17/30575; H04L 67/42; H04L 67/1095

(57) ABSTRACT

A method for synchronizing business data in a networked or cloud computing arrangement between a model-based business application server and a client-side computing device, which can operate in either online or offline modes, involves providing, on the client-side computing device, a copy of a property model used on the server-side by the application server to process business data. The method further includes, when the client-side computing device is offline, processing locally stored business data on the client-side computing device with reference to the copy of the property model, and later, when the client-side computing device comes online, synchronizing the locally stored business data on the client-side computing device and business data stored on the application server side.

### BACKGROUND

Computing solutions or applications (e.g., business applications including enterprise resource planning (ERP), enterprise content management (ECM), business process management (BPM) and product lifecycle management applications, etc.) are commonly installed on “backend” computer systems that deal with databases and have data processing components. Each backend computer system's infrastructure may consist of one or more physical machines, virtual machines, central processing units, data storage devices, disk drives and other resources, distributed over diverse locations or nodes connected by a computer network or the Internet. Some business applications may be interactive. Such business applications, for example, may have a user interface on a “frontend” client device (e.g., laptop computer, desktop computer, notebook computer, etc.) through which users (e.g., business users) can query, modify or input data (data stored in business databases) and view results instantaneously. The users may also run analytics and reports instantaneously. Users on client computing devices can connect to a backend computer system (via the Internet or other computer networks) and use a business application agent to access or manipulate business data stored in databases hosted on the backend computer system. The users may also use the business application agent or other application to access or manipulate business data stored locally on the client computing devices.

A substantial part of the backend business application logic may be directed to controlling or managing use of various functions of the business application in diverse circumstances. The use of various functions of the business application may be controlled or managed, for example, based on properties of the various data objects processed by the functions (e.g., processes for display of data in interactive user interfaces on client computing devices). The properties of the data objects may be used by the backend business application logic to determine, for example, whether data on the client computing devices are read-only or editable, whether data fields in a business form are optional or mandatory, whether user interface elements (e.g., buttons) in a form are disabled or enabled, etc.

The client computing devices can be “online” or “offline.” The terms “online” and “offline” may have specific meanings in regard to computer technology and telecommunications in which “online” indicates a state of connectivity, while “offline” indicates a disconnected state. Users may interactively prepare or modify data (including business objects such as data input forms, purchase orders, sales quotes, invoices, etc.) for consumption or processing by the business application when connected online to the backend computer system. Conversely, users may prepare new data or modify data (including business objects such as data input forms, purchase orders, sales quotes, invoices, etc.) locally on the client computing devices when offline, and later, when online, upload or transmit the new data or modified data to the backend computer system for consumption or processing by the business application.

Consideration is now being given to systems and methods for synchronizing data on backend computer systems, which host business applications, and data on frontend client computing devices, which operate or interact with the business applications in either online or offline modes.

### SUMMARY

A networked or cloud computing arrangement, at its backend, includes a model-based business application server hosting a business application. The model-based business application server is coupled to a backend database, which may store business data processed or manipulated by the business application. A computer network connection makes the model-based business server accessible to a client-side computing device, which may also store business data. The client-side computing device can operate in either online or offline modes.

In a general aspect, a method for synchronizing business data in the networked or cloud computing arrangement between the model-based business application server and the client-side computing device includes providing, on the client-side computing device, a copy of a property model used by the model-based application server to process business data. The property model may have data object definitions, which are extended by imposing data typing including one or more of a representation format, a default value, and legal operations, constraints and restrictions, etc. The copy of the property model installed on the client-side computing device is coded in XML, language and is agnostic to the programming language used on the application server side.

In an aspect of the method, when the client-side computing device is offline, processing locally stored business data on the client-side computing device can occur with reference to the copy of the property model provided on the client-side computing device. Processing locally stored business data on the client-side computing device involves using a model-interpretation engine installed on the client-side computing device to determine or calculate the properties of a data object with reference to the copy of the property model installed on the client-side computing device.

In a further aspect, the method involves, when the client-side computing device is later online, synchronizing the locally stored business data on the client-side computing device and the business data on the application server side. Synchronizing the locally stored business data on the client-side computing device includes updating the copy of the property model provided on the client-side computing device to reflect any changes in the property model used on the application server side.

The details of one or more implementations are set forth in the accompanying drawings and the description below. Other features will be apparent from the description and drawings, and from the claims.

### BRIEF DESCRIPTION OF THE DRAWINGS

FIG. 1 is a schematic block diagram illustrating an example system, which may be used to implement a business computing solution, in accordance with the principles of the present disclosure.

FIG. 2 illustrates an example method for synchronizing business data, in a networked or cloud computing arrangement, between a server and a client-side computing device, which can operate in either online or offline modes, in accordance with the principles of the present disclosure.

Like reference symbols in the various drawings indicate like elements.

The details of one or more implementations are set forth in the accompanying drawings and the description below. Other features will be apparent from the description and drawings, and from the claims.

### DETAILED DESCRIPTION

A “business” computing solution may involve a backend computer system including a backend model driven application server. The application server may host a business application (e.g., a business application such as an enterprise resource planning (ERP), an enterprise content management (ECM), a business process management (BPM), or a product lifecycle management application, etc.) and one or more frontend delivery vehicles (mobile apps, web browsers, desktop applications, connected objects, application agents, etc.) that are hosted on client computing devices (e.g., laptop computers, desktop computers, mobile devices, smartphones, etc.). The computing solution may, for example, involve manipulating, preparing or consuming business data, which may be stored in “backend” databases in the backend computer system, and also involve manipulating, preparing or consuming business data, which may be stored in “local” databases or data stores in the client computing devices.

Usually in programming, an attribute is a specification that defines a property of an object, element, or file. The attribute may also refer to, or set, the specific value for a given instance of the property of the object, element, or file. For convenience in description, the term attribute may be treated herein as being equivalent to a property. An attribute of a data object may, for example, consist of a name and a value; of an element, a type or class name; of a file, a name and extension, etc. Each named attribute may have an associated set of rules called operations. Example rules or operations may, for example, include: characters are not to be summed; an integer array is not to be manipulated and processed as an image object; text is not to be processed as type floating point (decimal numbers); etc. In general, data object definition can be extended by imposing data typing: a representation format, a default value, and legal operations (rules) and restrictions, etc., or conversely, may be viewed as attributes or properties of that data object's type.

In the business application hosted on the backend application server, business rules, specific to how things are done in or by a business, may be determined by the structure of a business data model. Further, in the business application, the business logic may be coded using, for example, Advanced Business Application Programming (ABAP) language. The ABAP code or scripts for manipulating, preparing or consuming business data objects may include functions that are dependent on properties of the data objects. For example, an ‘amount’ field of an invoice may be ‘read-only’ if a property ‘status’ of the invoice is ‘Sent’. The business application logic may determine or calculate the properties (and the associated operations) of a data object with reference to a ‘property’ model, which may define properties or attributes of the data objects in the business application. For example, the business logic may determine that an invoice has a property status ‘in preparation’ and accordingly calculate or set the ‘amount’ field of the invoice to be ‘editable’. If the calculated properties of a data object are incorrect or missing, then it may be expected that the business data generated or consumed by the business application will be inconsistent.

When the client computing devices are online i.e. connected to the backend computer system (e.g., a model driven application server), the business application logic may determine or calculate the properties (and the associated operations) of data objects. Users may manipulate, prepare or consume business data on the client computing devices using up to date properties of the data objects determined or calculated by the backend application server when the client computing devices are online. However, when the client computing devices are offline, the properties of the data objects (manipulated, prepared or consumed) on the client computing devices may be indeterminable. This may result in inconsistency or error when the business data processed on the offline client computing devices is later uploaded to the backend application server.

In accordance with the principles of the present disclosure, a copy of the property model used by the business application in the backend application server is installed on a client computing device for use, for example, when the client computing device is offline and is not connected to the backend application server. Further, a model-interpretation engine may be installed on the client computing device. The model-interpretation engine may be configured to interpret the copy of the property model installed on the client computing device and determine or calculate the properties (and the associated operations) of data objects stored in “local” databases or data stores in the client computing device. The model-interpretation engine may be used to determine or calculate the properties of data objects, for example, when the client computing device is offline.

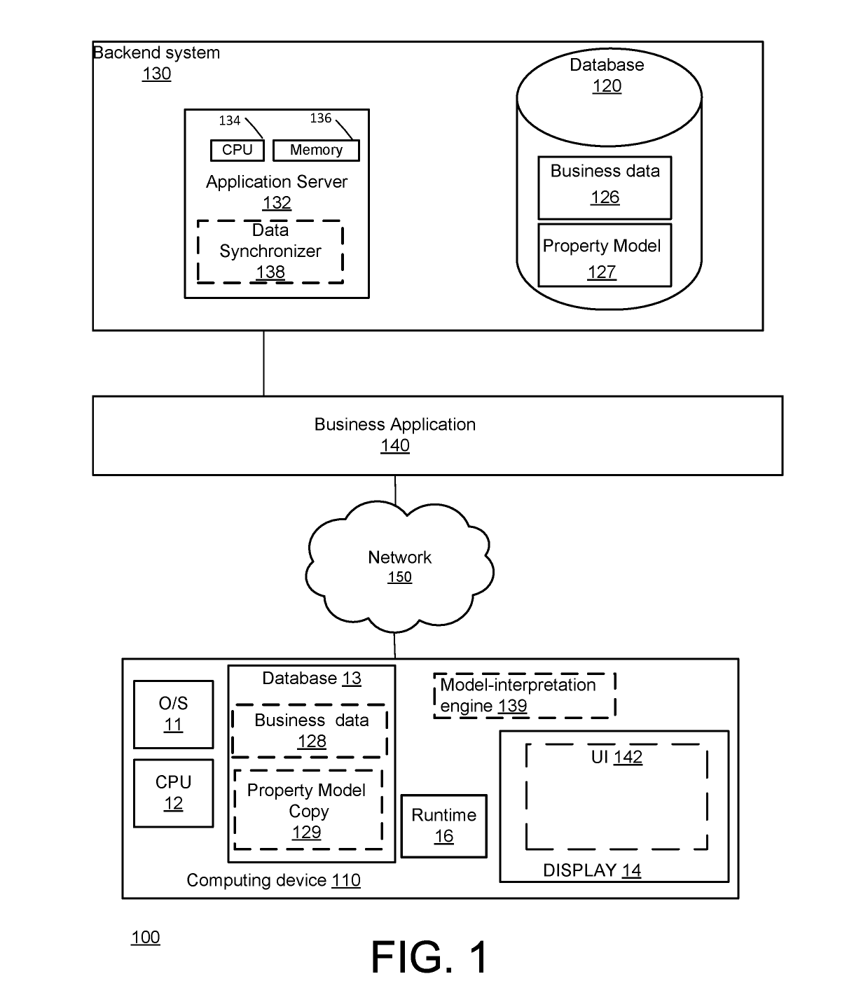

FIG. 1 shows a schematic block diagram of a system 100, which may be used to implement a business computing solution, in accordance with the principles of the present disclosure.

System 100 may include a backend computer system 130, which includes an application server 132. Application server 132, which may be a model driven application server, may host a business application 140, and may be connected to one or more client computing devices (e.g., client computing device 110) via a computer network or the Internet (e.g., network 150).

Business application 140 may have a frontend (e.g., UI 142, which may include frontend delivery vehicles, application agents, web browsers, etc.) presented on a client computing device 110 through which a user can operate or interact with business application 140.

Backend computer system 130 may include one or more servers (e.g., application server 132) to run business application 140 and one or more databases (e.g., database 120), which may store data (e.g., business data 126) that is manipulated or processed by business application 140. Application server 132 may include one or more CPUs and memories (e.g., CPU 134 and memory 136), which may be configured to deliver, for example, various content (e.g., business data 126, application agents, web browsers, frontend user interface (UI 142), data storage, etc.) to client computing devices (e.g., client computing device 110) via a computer network 150 or the Internet.

A client computing device (e.g., client computing device 110) may, for example, be a desktop computer, a notebook computer, a netbook computer, a tablet computer, a smartphone or another mobile computing device, etc. An example client computing device (e.g., client computing device 110) may include an operating system (e.g., O/S 11), one or more processors (e.g., CPU 12), one or more memories or data stores (e.g., database 13), and a display (e.g., display 14). Computing device 110 may execute a runtime 16 and various applications (e.g., a web application, a word processing application, a spreadsheet application, business application 140 agents, etc.) to process locally stored data (e.g., business data 128) for business application 140.

Business application 140, which may be coded using, for example, Advanced Business Application Programming (ABAP) or JavaScript programming languages, may include functions and operations that are dependent on properties of the data objects (e.g., business data 126) being processed by business application 140. The properties of the data objects may be described, for example, in a property model (e.g., property model 126, which may be stored in database 120). A copy of the property model and a model-interpretation engine may be installed on client device 110 (e.g., property model copy 129 and model-interpretation engine 139).

Application server 132/business application 140 may be configured to determine or calculate properties of the data objects being processed by business application 140 by reference to property model 126. The data objects being processed by application server 132/business application 140 may include business data 126 stored on the server side and also include business data 128 on the client side when the client computing device (e.g., client computing device 110) is online and in communication with application server 132. Similarly, client computing device 110/model interpretation engine 139 may be configured to determine or calculate properties of the data objects being processed on client computing device 110 (e.g. by business application 140 agents) by reference to property model copy 129 when client computing device 110 is off-line and is not in communication with application server 132.

Further, application server 132 may include a data synchronizer 138, which may be configured to update or synchronize applications data over network 150, so that applications on client computing device 110 and applications on backend computer system 130 have, for example, the same data to work with. Data synchronizer 138 may, for example, be configured to synchronize data (e.g., business data 126 and property model 127 stored in database 120) available to business application 140 on the server side and the data (e.g., business data 128 and property model copy 129 stored in database 13) available for business application 140 on client computing device 110. Data synchronizer 138 may monitor the data stored in database 120 and the data stored in database 13, and update or synchronize the data records in the databases at regular or pre-determined intervals, or in response to specific events (e.g., when a user logs in on a client device, when the client device comes online or upon user request).

When the client computing devices are offline (i.e. disconnected from the backend computer system), users may manipulate, prepare or consume data (e.g., business data 128) stored in “local” databases or data stores (e.g., database 13) in the client computing devices using the frontend delivery vehicles (e.g., application agents, web browsers, etc.). For this purpose, client runtime 16 in computing device 110 may utilize model-interpretation engine 139 to determine or calculate properties of data objects with reference to locally stored property model copy 129 in a manner which may be the same as, or similar to, the manner in which application server 132 determines or calculates properties of data objects with reference to property model 127 on the server side. However, property model copy 129 may be provide property definitions coded in language (e.g., XML) which is agnostic to application server 132 languages (which. for example, may be ABAP or Jscript).

A snippet of an example property model in XML, is as follows:

```
      : <?xml version=“1.0”?>
      <BusinessLogic
BOName=“CUSTOMER_QUOTE” CreatedBy=“SCHULTEO” CreatedAt=“20150327151715.7851040”
ChangedBy=“VUMMITI” ChangedAt=“20150629033635.5658250”
BoEsrName=“CustomerQuote” BoEsrNamespace=“http://sap.com/xi/AP/CRM/Global”
xmlns=“http://sap.com/a1s/cd/oberon/sapModeledBusinessLogic”>
        <Rules>
        <Rule nodeEsrName=“Root” node=“ROOT” priority=“10”
name=“COMPLETED”>
          <And>
          <AttributeComparison
operator=“Equals” compareValue=“CO_COMPLETED” interface=“CL_CUSTOMER_QUOTE_CONSTANTS”
attributeName=“STATUS-AG_QUOTE_LC_STATUS_CODE” name=“COMPLETED”
id=“00163E07C01D1ED4B592EAA94146EDA3”/>
          </And>
          <Description>Evaluates to true if Root lifecycle status code is
completed</Description>
          </Rule>
          <Rule nodeEsrName=“Root” node=“ROOT” priority=“10”
name=“OPEN_ITEMS” solution=“$CUST”>
          <And>
            <ExistenceCheck
name=“OPEN_ITEMS” id=“00163E07C01D1ED4B5932700510EAE1D” path=“/OPEN_ITEMS”/>
            </And>
          </Rule>
        </Rules>
        <Properties>
          <AttributeProperty
including=“*/*” excluding=“/BTD_REFERENCE/*” isUsedForReadOnly=“true” isUsed
ForDisabled=“false” rule=“COMPLETED”/>
          <AttributeProperty
including=“TYPE_CODE” isUsedForReadOnly=“true” rule=“OPEN_ITEMS”/>
          <ActionProperty
including=“*” excluding=“ADD_REFERENCE_WITH_DATA” isUsedForDisabled=“true”
rule=“COMPLETED”/>
        </Properties>
      </BusinessLogic>)
```

An example XML schema, which describes the structure of a property model, is as follows:

```
<?xml version=“1.0” encoding=“utf-8”?>
  <xs:schema id=“sapModeledBusinessLogic”
      targetNamespace=“http://sap.com/a1s/cd/oberon/sapModeledBusinessLogic”
      elementFormDefault=“qualified”
      xmlns=“http://sap.com/a1s/cd/oberon/sapModeledBusinessLogic”
      xmlns:xs=“http://www.w3.org/2001/XMLSchema”
    >
  <xs:complexType name=“RulesType”>
  <xs:sequence>
    <xs:element name=“Rule” type=“RuleType” minOccurs=“0”
maxOccurs=“unbounded”/>
  </xs:sequence>
  </xs:complexType>
  <xs:group name=“PropertyGroupType”>
  <xs:choice>
    <xs:element name=“AttributeProperty” type=“AttributePropertyType” />
    <xs:element name=“ActionProperty” type=“ActionPropertyType” />
  </xs:choice>
  </xs:group>
  <xs:complexType name=“PropertiesType”>
  <xs:sequence>
    <xs:group ref=“PropertyGroupType” minOccurs=“0” maxOccurs=“unbounded” />
  </xs:sequence>
  </xs:complexType>
  <xs:complexType name=“RuleType”>
  <xs:sequence>
    <xs:group ref=“AndOrGroupType” minOccurs=“0” maxOccurs=“unbounded” />
    <xs:element name=“Description” type=“DescriptionType” minOccurs=“0”
maxOccurs=“1” />
  </xs:sequence>
  <xs:attribute name=“nodeEsrName” type=“xs:string” use=“required”/>
  <xs:attribute name=“node” type=“xs:string” use=“required”/>
  <xs:attribute name=“priority” type=“xs:integer” use=“optional”/>
  <xs:attribute name=“name” type=“xs:string” use=“required”/>
  <xs:attribute name=“solution” type=“xs:string” use=“optional”/>
  </xs:complexType>
  <xs:complexType name=“DescriptionType”>
  <xs:simpleContent>
    <xs:extension base=“xs:string”>
    </xs:extension>
  </xs:simpleContent>
  </xs:complexType>
  <xs:complexType name=“PropertyBaseType”>
  <xs:attribute name=“rule” type=“xs:string” use=“required”/>
  <xs:attribute name=“including” type=“xs:string” use=“required”/>
  <xs:attribute name=“excluding” type=“xs:string” use=“optional”/>
  </xs:complexType>
  <xs:complexType name=“AttributePropertyType”>
  <xs:complexContent>
    <xs:extension base=“PropertyBaseType”>
    <xs:attribute name=“isUsedForReadOnly” type=“xs:boolean” use=“optional”
default=“false”/>
    <xs:attribute name=“isUsedForDisabled” type=“xs:boolean” use=“optional”
default=“false”/>
    <xs:attribute name=“isUsedForMandatory” type=“xs:boolean” use=“optional”
default=“false”/>
    </xs:extension>
  </xs:complexContent>
  </xs:complexType>
  <xs:complexType name=“ActionPropertyType”>
  <xs:complexContent>
    <xs:extension base=“PropertyBaseType”>
    <xs:attribute name=“isUsedForDisabled” type=“xs:boolean” use=“optional”
default=“false”/>
    </xs:extension>
  </xs:complexContent>
  </xs:complexType>
  <xs:complexType name=“AndConditionType”>
  <xs:sequence>
    <xs:group ref=“ConditionGroupType” minOccurs=“1” maxOccurs=“unbounded” />
  </xs:sequence>
  </xs:complexType>
  <xs:complexType name=“OrConditionType”>
  <xs:sequence>
    <xs:group ref=“ConditionGroupType” minOccurs=“1” maxOccurs=“unbounded” />
  </xs:sequence>
  </xs:complexType>
  <xs:complexType name=“ConditionType”>
  <xs:attribute name=“name” type=“xs:string” use=“required”/>
  <xs:attribute name=“id” type=“xs:string” use=“required”/>
  </xs:complexType>
  <xs:simpleType name=“AttributeComparisonOperatorType”>
  <xs:restriction base=“xs:string”>
    <xs:enumeration value=“Equals”/>
    <xs:enumeration value=“NotEquals”/>
    <xs:enumeration value=“LessThan”/>
    <xs:enumeration value=“LessThanOrEqual”/>
    <xs:enumeration value=“GreaterThan”/>
    <xs:enumeration value=“GreaterThanOrEqual”/>
  </xs:restriction>
  </xs:simpleType>
  <xs:complexType name=“AttributeComparisonConditionType”>
  <xs:complexContent>
    <xs:extension base=“ConditionType”>
    <xs:attribute name=“interface” type=“xs:string” use=“required”/>
    <xs:attribute name=“compareValue” type=“xs:string” use=“required”/>
    <xs:attribute name=“attributeName” type=“xs:string” use=“required”/>
    <xs:attribute name=“operator” type=“AttributeComparisonOperatorType”
use=“required”/>
    </xs:extension>
  </xs:complexContent>
  </xs:complexType>
  <xs:complexType name=“ExistenceCheckConditionType”>
  <xs:complexContent>
    <xs:extension base=“ConditionType”>
    <xs:attribute name=“path” type=“xs:string” use=“required”/>
    </xs:extension>
  </xs:complexContent>
  </xs:complexType>
  <xs:complexType name=“ESIConstraintConditionType”>
  <xs:complexContent>
    <xs:extension base=“ConditionType”>
    <xs:attribute name=“esiConstraintType” type=“xs:string” use=“required”/>
    <xs:attribute name=“esiConstraintValue” type=“xs:string” use=“required”/>
    <xs:attribute name=“esiConstraintIndicator” type=“xs:boolean” use=“required”/>
    </xs:extension>
  </xs:complexContent>
  </xs:complexType>
  <xs:complexType name=“InstanceSavedConditionType”>
  <xs:complexContent>
    <xs:extension base=“ConditionType”>
    <xs:attribute name=“instanceSaved” type=“xs:boolean” use=“required”/>
    </xs:extension>
  </xs:complexContent>
  </xs:complexType>
  <xs:complexType name=“RuleConditionType”>
  <xs:complexContent>
    <xs:extension base=“ConditionType”>
    <xs:attribute name=“referenceRule” type=“xs:string” use=“required”/>
    </xs:extension>
  </xs:complexContent>
  </xs:complexType>
  <xs:group name=“ConditionGroupType”>
  <xs:choice>
    <xs:element name=“AttributeComparison”
type=“AttributeComparisonConditionType” />
    <xs:element name=“ExistenceCheck” type=“ExistenceCheckConditionType” />
    <xs:element name=“ESIConstraint” type=“ESIConstraintConditionType” />
    <xs:element name=“InstanceSaved” type=“InstanceSavedConditionType” />
    <xs:element name=“Rule” type=“RuleConditionType” />
    <xs:element name=“And” type=“AndConditionType” />
    <xs:element name=“Or” type=“OrConditionType” />
  </xs:choice>
  </xs:group>
  <xs:group name=“AndOrGroupType”>
  <xs:choice>
    <xs:element name=“And” type=“AndConditionType” />
    <xs:element name=“Or” type=“OrConditionType” />
  </xs:choice>
  </xs:group>
  <xs:simpleType name=“PropertyTypeType”>
  <xs:restriction base=“xs:string”>
    <xs:enumeration value=“attribute”/>
    <xs:enumeration value=“action”/>
    <xs:enumeration value=“association”/>
  </xs:restriction>
  </xs:simpleType>
  <xs:element name=“BusinessLogic”>
  <xs:complexType>
    <xs:sequence>
    <xs:element name=“Rules” type=“RulesType” minOccurs=“0” maxOccurs=“1”/>
    <xs:element name=“Properties” type=“PropertiesType” minOccurs=“0”
maxOccurs=“1”/>
    </xs:sequence>
    <xs:attribute name=“BOName” type=“xs:string” use=“required”/>
    <xs:attribute name=“BoEsrName” type=“xs:string” use=“required”/>
    <xs:attribute name=“BoEsrNamespace” type=“xs:string” use=“required”/>
    <xs:attribute name=“CreatedBy” type=“xs:string” use=“required”/>
    <xs:attribute name=“CreatedAt” type=“xs:string” use=“required”/>
    <xs:attribute name=“ChangedBy” type=“xs:string” use=“required”/>
    <xs:attribute name=“ChangedAt” type=“xs:string” use=“required”/>
    </xs:complexType>
  </xs:element>
  </xs:schema>
```

In an example business use case, system 100 (shown in FIG. 1) may be used by a sales representative, for example, to create sales quotes on client computing device 110 in either online mode or offline mode. The sales representative may create, update and delete business data (e.g., business data 126) in the cloud with client computing device 110 in online mode (i.e., connected to application server 132). The sales representative may synchronize the server-side business data (e.g., business data 126) and the property models (e.g., property model 127) to her client computing device 110. When a network connection to application server 132 is not available and with client computing device 110 in offline mode, the sales representative may still work with the previously synchronized data (e.g., business data 128) locally available on client computing device 110. The sales representative may, for example, change the data (e.g., create a new sales quote) according to property model copy 129 on client computing device 110. Using the modeled data properties when client computing device 110 is in the offline mode may ensure that the data changes made by the sales representative (e.g., when creating the new sales quote) are consistent and compatible with the server-side business data (e.g., business data 126). When a network connection to application server 132 become available again and client computing device 110 can come online, the sales representative may resynchronize the changed data (e.g., the new sales quote) to the cloud. Resynchronizing the changed data using property model copy 129 on client computing device 110 data consistency may result in fewer data consistency errors.

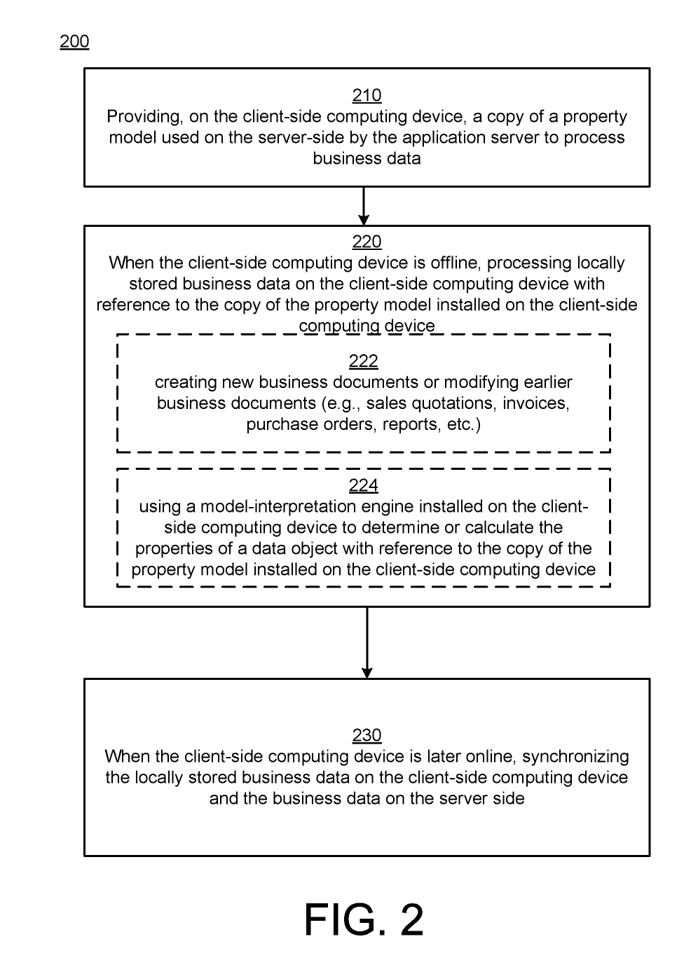

FIG. 2 illustrates an example method 200 for synchronizing business data in a networked or cloud computing arrangement between a server and a client-side computing device, which may operate in either online or offline modes, in accordance with the principles of the present disclosure. The server may be a model-based application server hosting a business application, which processes the business data with reference to a property model of the business data. The business application may have a frontend (including frontend UI components, application agents, web browsers, etc.) presented on the client-side computing device through which a user can operate or interact with the business application. Example method 200 may be implemented in any networked or cloud computing arrangement (e.g., system 100, FIG. 1).

Method 200 includes providing, on the client-side computing device, a copy of a property model used on the server-side by the application server to process the business data (210), and when the client-side computing device is offline, processing locally stored business data on the client-side computing device with reference to the copy of the property model installed on the client-side computing device (220). The client-side computing device may be offline, for example, because of an unavailability or failure of a network or Internet connection to the application server. The application server and the business application may be coded, for example, in Advanced Business Application Programming (ABAP) or JavaScript programming languages. In contrast, the copy of the property model installed on the client-side computing device may be coded in XML language and may be agnostic to the programming languages used on the server-side. The property model may include data object definitions which may be extended by imposing data typing (e.g., a representation format, a default value, and legal operations (rules), constraints and restrictions, etc.).

In method 200, processing locally stored business data on the client computing device 220 may, for example, include creating new business documents or modifying earlier business documents (e.g., sales quotations, invoices, purchase orders, reports, etc.) on the client-side computing device (222).

Further, processing locally stored business data on the client-side computing device 220 may include using a model-interpretation engine installed on the client-side computing device to determine or calculate the properties of a data object with reference to the copy of the property model installed on the client-side computing device (224).

After processing locally stored business data on the client-side computing device 220, method 200 may include, when the client computing device is later online, synchronizing the locally stored business data on the client-side computing device and the business data on the server side (230). The locally stored business data on the client-side computing device may, for example, include business documents that were created or modified when the client-side computing device was offline. The business data on the server-side may include business documents that were created or modified on the server-side when the client-side computing device was offline. Further synchronizing the locally stored business data on the client-side computing device 230 may include updating the copy of the property model installed on the client-side computing device to reflect any changes in the property model used on the server-side.

The various systems, apparatus or techniques described herein may be implemented in digital electronic circuitry, or in computer hardware, firmware, software, or in combinations of them. The systems, apparatus and techniques may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Methods (e.g. method 200) may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems, apparatus or techniques may be implemented in a computing system that includes a backend component, e.g., as a data server, or that includes a middleware component, e.g., an application server, or that includes a frontend component, e.g., a client computer having a graphical user interface or a Web browser through which a user can interact with an implementation, or any combination of such backend, middleware, or frontend components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A method for synchronizing business data in a networked or cloud computing arrangement between a model-based business application server and a client-side computing device, which can operate in either online or offline modes, the method comprising:
providing, on the client-side computing device, a copy of a property model used on by the application server to process business data; and
when the client-side computing device is offline, processing locally stored business data on the client-side computing device with reference to the copy of the property model provided on the client-side computing device.

2. The method of claim 1, wherein processing locally stored business data on the client-side computing device includes creating new business documents or modifying earlier business documents on the client-side computing device.

3. The method of claim 1, wherein processing locally stored business data on the client-side computing device includes using a model-interpretation engine installed on the client-side computing device to determine or calculate the properties of a data object with reference to the copy of the property model installed on the client-side computing device.

4. The method of claim 1, wherein providing a copy of a property model used by the application server to process business data includes providing a copy of a property model having data object definitions extended by imposing data typing including one or more of a representation format, a default value, and legal operations, constraints and restrictions.

5. The method of claim 1 further comprising, when the client-side computing device is later online, synchronizing the locally stored business data on the client-side computing device and the business data on the application server side.

6. The method of claim 5, wherein synchronizing the locally stored business data on the client-side computing device includes updating the copy of the property model provided on the client-side computing device to reflect any changes in the property model used on the application server side.

7. The method of claim 1, wherein the copy of the property model installed on the client-side computing device is coded in XML language and is agnostic to the programming language used on the application server side.

8. A non-transitory, machine-readable medium having instructions stored thereon, the instructions, when executed by a processor:
providing, on a client-side computing device, a copy of a property model used by a model-based business application server in a networked or cloud computing arrangement to process business data; and
when the client-side computing device is offline, processing locally stored business data on the client-side computing device with reference to the copy of the property model provided on the client-side computing device.

9. The non-transitory, machine-readable medium of claim 8, wherein
processing locally stored business data on the client-side computing device includes creating new business documents or modifying earlier business documents on the client-side computing device.

10. The non-transitory, machine-readable medium of claim 8, wherein processing locally stored business data on the client-side computing device includes using a model-interpretation engine installed on the client-side computing device to determine or calculate the properties of a data object with reference to the copy of the property model provided on the client-side computing device.

11. The non-transitory, machine-readable medium of claim 8, wherein providing a copy of a property model used by the application server to process business data includes providing a copy of a property model having data object definitions extended by imposing data typing including one or more of a representation format, a default value, and legal operations, constraints, and restrictions.

12. The non-transitory, machine-readable medium of claim 8, wherein the instructions, when executed by a processor, further cause, when the client computing device is later online, synchronization of the locally stored business data on the client-side computing device and the business data on the application server side.

13. The non-transitory, machine-readable medium of claim 12, wherein synchronization of the locally stored business data on the client-side computing device includes updating the copy of the property model provided on the client-side computing device to reflect any changes in the property model used on the application server side.

14. The non-transitory, machine-readable medium of claim 12, wherein the copy of the property model installed on the client-side computing device is coded in XML language and is agnostic to the programming language used on the application server side.

15. A system comprising:
a networked or cloud computing arrangement including a model-based business application server and a client-side computing device, which can operate in either online or offline modes,
wherein the client-side computing device has a copy of a property model used by the application server to process business data, and
wherein the client computing device is configured, when offline, for processing locally stored business data on the client-side computing device with reference to the copy of the property model in the client-side computing device.

16. The system of claim 15, wherein processing locally stored business data on the client-side computing device includes creating new business documents or modifying earlier business documents on the client-side computing device.

17. The system of claim 15, wherein processing locally stored business data on the client-side computing device includes using a model-interpretation engine installed on the client-side computing device to determine or calculate the properties of a data object with reference to the copy of the property model in the client-side computing device.

18. The system of claim 15, wherein the property model used by the application server to process business data includes data object definitions extended by imposing data typing including one or more of a representation format, a default value, and legal operations, constraints and restrictions.

19. The system of claim 15 further configured for synchronizing, when the client-side computing device is later online, the locally stored business data on the client-side computing device and the business data on the application server side.

20. The system of claim 19, wherein synchronizing the locally stored business data on the client-side computing device includes updating the copy of the property model provided on the client-side computing device to reflect any changes in the property model used on the application server side.
